(19) United States
(12) Patent Application Publication
(10) Pub. No.: US 2009/0303183 A1
(43) Pub. Date: Dec. 10, 2009

(54) PALM SUPPORT STRUCTURE OF MOUSE

(75) Inventor: Koan-Ting Chen, Kaohsiung City (TW)

Correspondence Address: APEX JURIS, PLLC, 12733 LAKE CITY WAY NORTHEAST, SEATTLE, WA, 98125, US

(73) Assignee: ARESON TECHNOLOGY CORP., Sanchung City (TW)

(21) Appl. No.: 12/136,505

(22) Filed: Jun. 10, 2008

(51) Int. Cl. G06F 3/041

(52) U.S. Cl. 345/163

(57) ABSTRACT

The present invention discloses a palm support structure of a mouse, and the palm support structure includes an ergonomic auxiliary body installed on a lateral edge or a rear position of a mouse body and combined with the mouse body. When a user operates the mouse, the user's palm is attached onto a surface of the mouse body surface, and the user's two outer fingers of the palm or the user's wrist are supported by the auxiliary body, such that the fingers or the wrist will not touch a tabletop directly to provide a comfortable operation of the mouse for users.

### BACKGROUND OF THE INVENTION

1. Field of the Invention

The present invention relates to a palm support structure of a mouse, and more particularly to a structure that provides users a comfortable grip of a mouse body by combining the mouse body with an auxiliary body.

2. Description of the Related Art

Referring to FIG. 1 for a conventional mouse, the structure of the mouse is a casing in a protruding arc shape, and comprises a base in a corresponding shape and disposed at the bottom of the casing, and a roller protruded from a front end of the casing. When this type of mouse is used, users generally touch the top of the casing by their index finger, middle finger and ring finger, and place their thumb, smaller finger or wrist on the left and right sides and rear portion of the casing respectively to move the mouse, and the thumb, smaller finger or wrist will be rubbed continuously with a tabletop, and discomfort or callus will be produced after a long time of use.

### SUMMARY OF THE INVENTION

In view of the shortcomings of the prior art, the inventor of the present invention based on years of experience in the related industry to conduct extensive researches and experiments, and finally developed a palm support structure of a mouse in accordance with the present invention.

The primary objective of the present invention is to overcome the shortcomings of the prior art by providing a palm support structure of a mouse, comprising a mouse body, a first connecting element disposed at a specified position on an edge of the mouse body, an auxiliary body disposed at a corresponding position, and a second connecting element disposed on the auxiliary body, such that when the mouse is used, the mouse body and the auxiliary body are combined by the first and second connecting elements for users to operate the mouse. When users place their palm on a surface of the mouse body, they can operate the mouse comfortably by the support of the auxiliary body without touching their palm with a tabletop or producing discomforts or calluses after a long time of use.

Another objective of the present invention is to provide a palm support structure of a mouse with an auxiliary body installed on a side or a rear portion of the mouse body.

A further objective of the present invention is to provide a palm support structure of a mouse with an auxiliary body for supporting outer fingers (such as their thumb, ring finger and smaller finger) of a user's palm and a wrist.

Another further objective of the present invention is to provide a palm support structure of a mouse with an auxiliary body having an ergonomic surface, and the surface is either a smooth cambered surface or a continuous wavy surface.

To make it easier for our examiner to understand the objects, shape, characteristics and performance of the present invention, we used preferred embodiments accompanied with related drawings for the detailed description of the invention as follows.

### BRIEF DESCRIPTION OF THE DRAWINGS

FIG. 1 is a schematic view of an apparatus in accordance with a prior art;

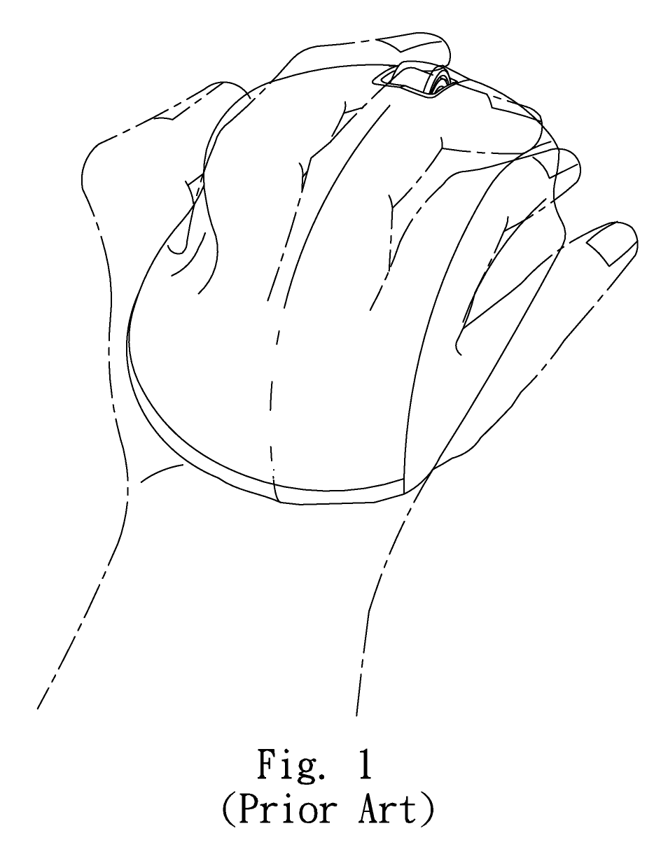

FIG. 2 is a schematic perspective view of a first preferred embodiment of the present invention;

FIG. 3 is an exploded view of a first preferred embodiment of the present invention;

FIG. 4 is a schematic view of an auxiliary body having a continuous wavy surface in accordance with the present invention;

FIG. 5 is a schematic view of operating a mouse with a palm support structure in accordance with a first preferred embodiment of the present invention;

FIG. 6 is a schematic perspective view of a second preferred embodiment of the present invention;

FIG. 7 is a schematic perspective view of a third preferred embodiment of the present invention;

FIG. 8 is a schematic perspective view of a fourth preferred embodiment of the present invention; and

FIG. 9 is a schematic perspective view of a fifth preferred embodiment of the present invention.

### DETAILED DESCRIPTION OF THE PREFERRED EMBODIMENTS

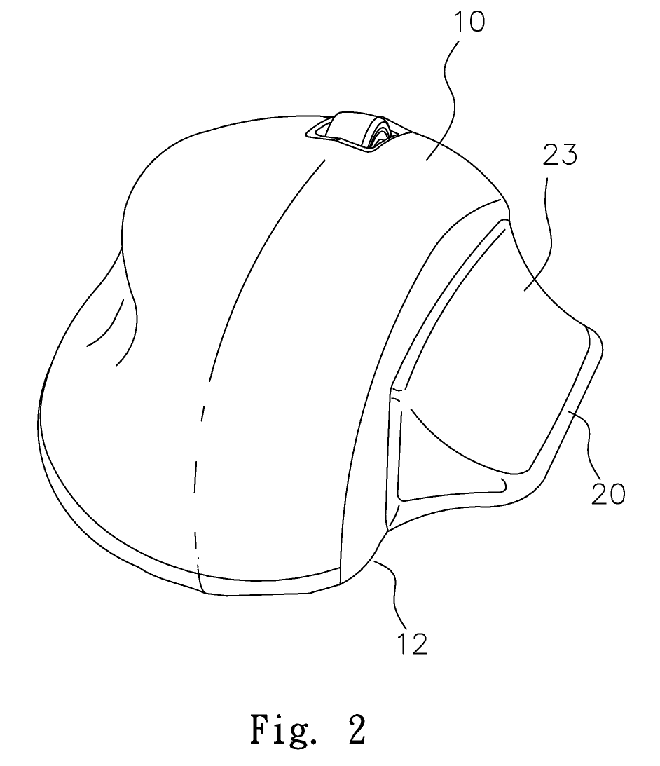

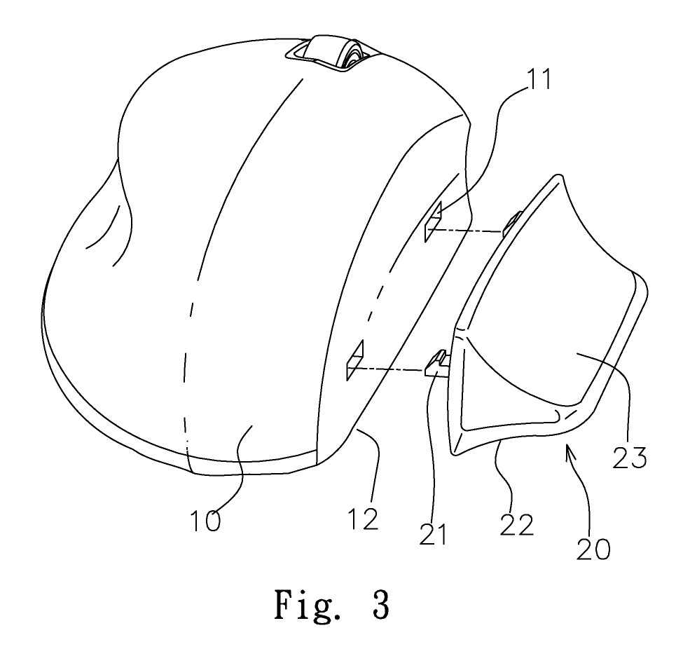

Referring to FIGS. 2 and 3 for a palm support structure of a mouse in accordance with a first preferred embodiment of the present invention, the mouse comes with a mouse body 10, and the internal structure of the mouse body 10 is the same as that of a general mouse, and thus will not be described here. In this embodiment, a first connecting element 11 which is an opening disposed on a right side of the mouse body 10, and an auxiliary body 20 is disposed outside the mouse body 10 and installed at a position corresponding to the first connecting element 11, and the auxiliary body 20 has a second connecting element 21 which is a hook in this embodiment and corresponds to the first connecting element 11. When the mouse is used, the mouse body 10 and the auxiliary body 20 are combined by the first and second connecting elements 11, 21.

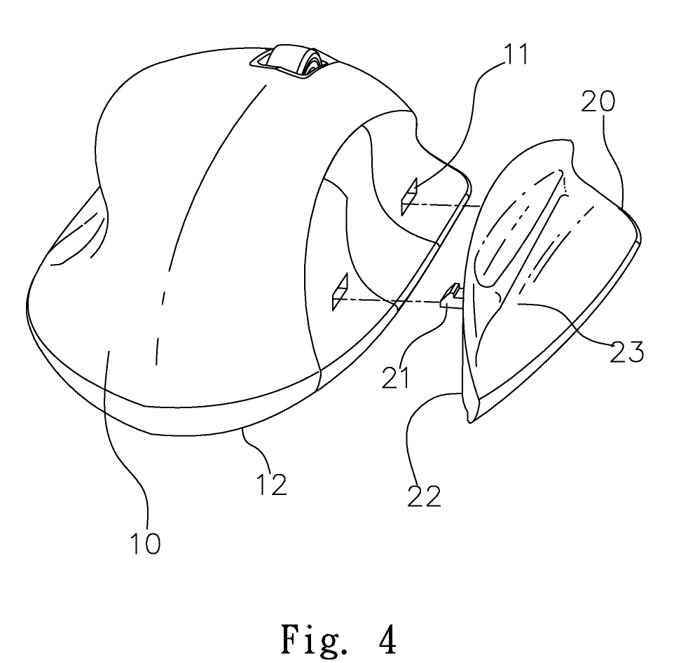

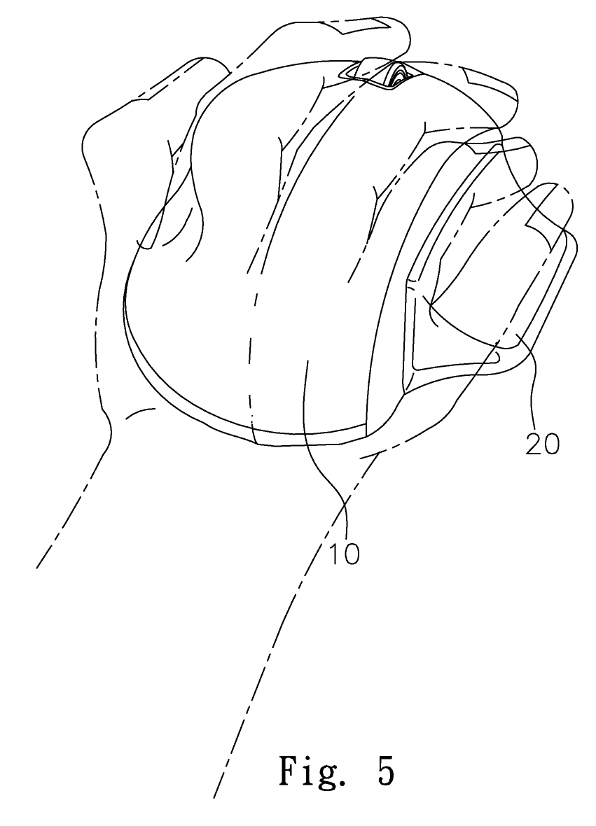

Further, the auxiliary body 20 comes with a bottom surface 22 aligned evenly with a body bottom surface 12 of the mouse body 10, such that if the mouse body 10 and the auxiliary body 20 are placed together on a tabletop, they can be placed flatly on the tabletop. In addition, the auxiliary body 20 comes with an ergonomic surface 23 adjacent to the bottom surface 22 of the auxiliary body 20, and the surface 23 of the auxiliary body 20 is a smooth cambered surface (as shown in FIG. 2) or a continuous wavy surface (as shown in FIG. 4) for supporting a user's thumb, ring finger or smaller finger. When the user operates the mouse, the user's index finger, middle finger and palm can touch the surface of the mouse body 10, and the ring finger and smaller finger lean on the surface 23 of the auxiliary body 20, so that the user can operate the mouse comfortably (as shown in FIG. 5). Since the ring finger and the smaller finger will not touch the tabletop directly, the ring finger and the smaller finger will not rub the tabletop when the user slides the mouse body 10, and thus the invention can prevent any possible injury or callus on the skin.

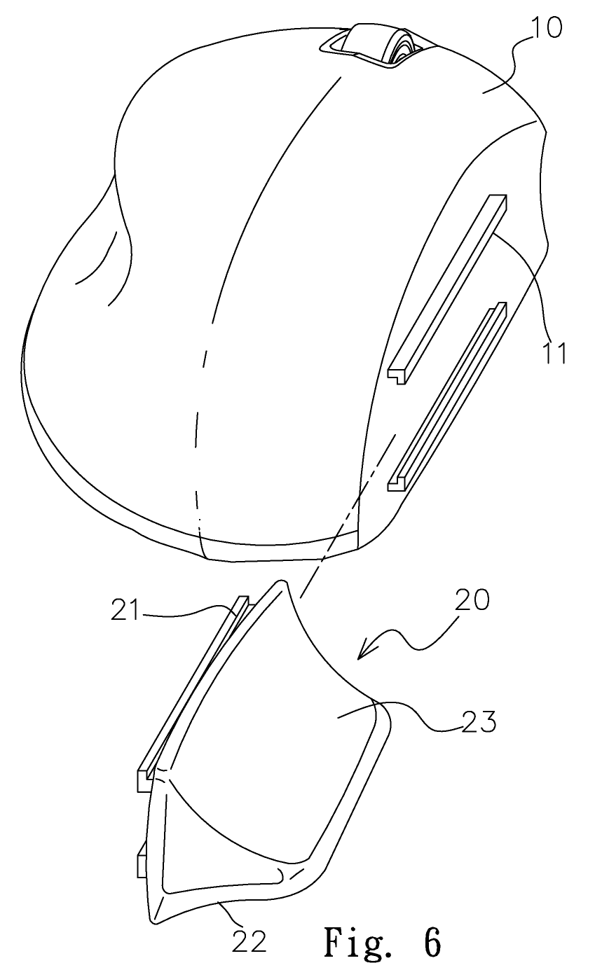

Referring to FIG. 6 for a second preferred embodiment of the present invention, the difference of this embodiment from the first preferred embodiment resides on that the mouse body 10 has a first connecting element 11 disposed on the right side of the mouse body 10, and an auxiliary body 20 disposed at a position corresponding to the first connecting element 11 of the mouse body 10, and the auxiliary body 20 has a second connecting element 21 corresponding to the first connecting element 11, and the first and second connecting elements 11, 21 are corresponding embedded groove and embedding member.

Further, the first and second connecting elements 11, 21 disposed on the mouse body 10 and corresponding to the auxiliary body 20 can be substituted by a magnetic material (such as a magnet).

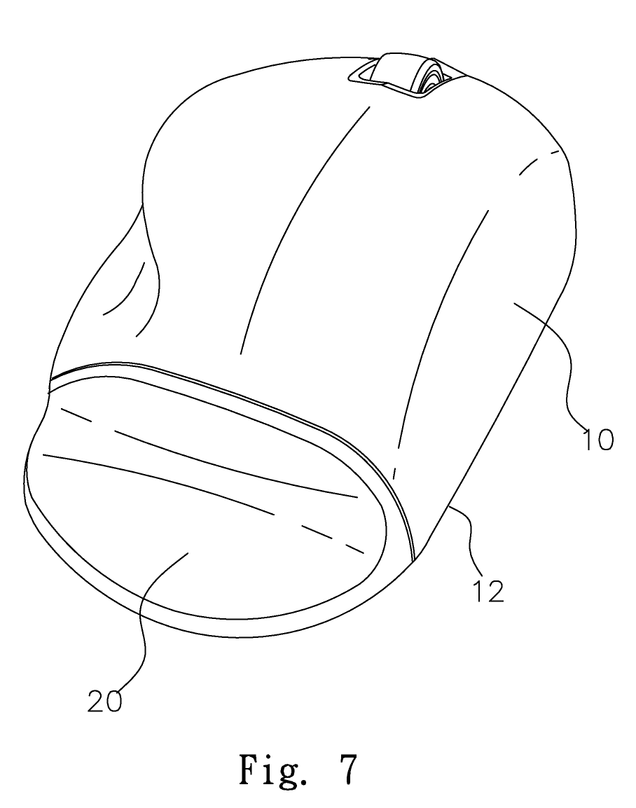

Referring to FIG. 7 for a third preferred embodiment of the present invention, the difference of this embodiment from the first preferred embodiment resides on that a first connecting element 11 (not shown in the figure) is disposed at a rear portion of the mouse body 10, and an auxiliary body 20 is installed outside the mouse body 10 and at a position corresponding to the first connecting element 11, and the auxiliary body 20 has a second connecting element 21 (not shown in the figure) corresponding to the first connecting element 11, such that the mouse body 10 and the auxiliary body 20 are combined at the rear portion of the mouse body 10 by the first and second connecting elements 11, 21.

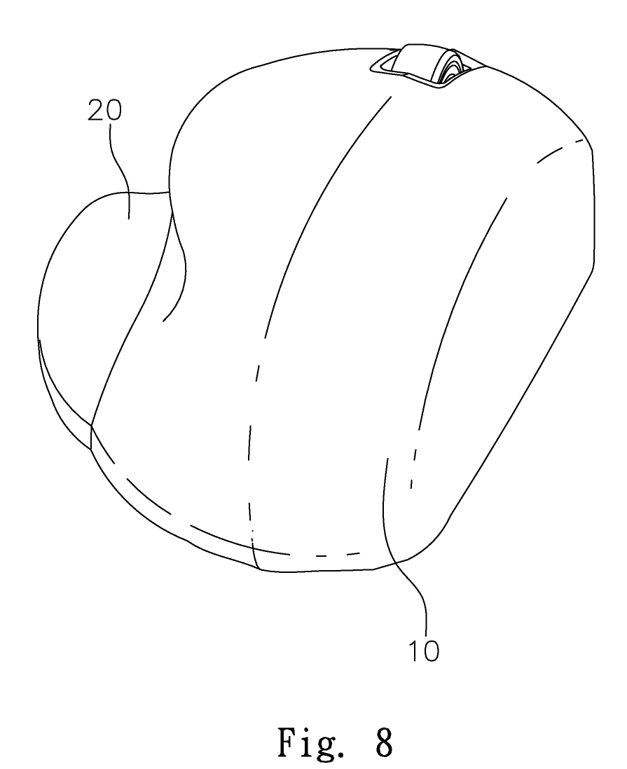

Referring to FIG. 8 for a fourth preferred embodiment of the present invention, the difference of this embodiment from the foregoing preferred embodiments resides on that an auxiliary body 20 is combined to the left side of the mouse body 10, and the auxiliary body 20 is installed outside the mouse body 10 and at a position corresponding to a first connecting element 11 (not shown in the figure), and the auxiliary body 20 has a second connecting element 21 (not shown in the figure) corresponding to the first connecting element 11, such that the auxiliary body 20 is combined with the mouse body 10 at the left side of the mouse body 10 by the first and second connecting elements 11, 21.

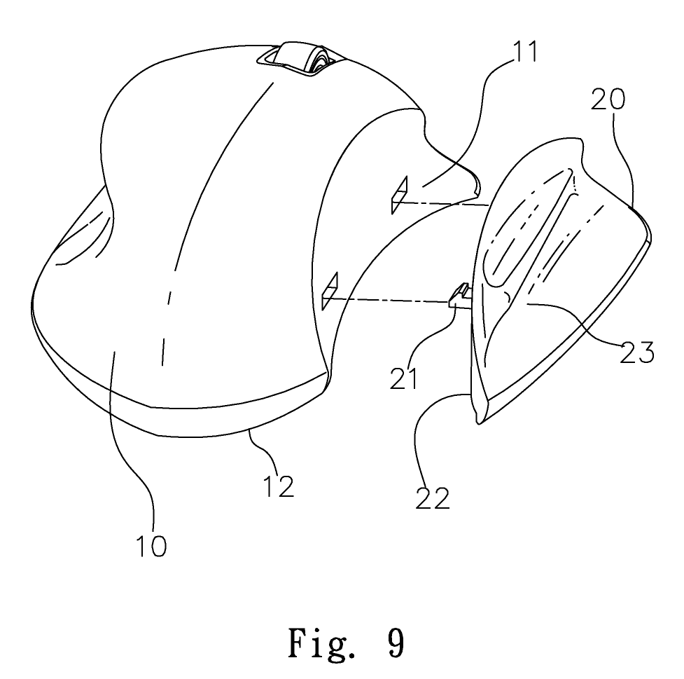

Referring to FIG. 9 for a fifth preferred embodiment of the present invention, the difference of this embodiment from the foregoing preferred embodiment resides on that the bottom surface 22 of the auxiliary body 20 is disposed on the top of the bottom surface 12 of the mouse body 10 to combine with the mouse body 10, and a specific distance is maintained between the bottom surface 22 of the auxiliary body 20 and a tabletop.

In summation of the above description, the present invention herein enhances the performance than the conventional structure and further complies with the patent application requirements and is thus duly filed for patent application.

While the invention has been described by means of specific embodiments, numerous modifications and variations could be made thereto by those skilled in the art without departing from the scope and spirit of the invention set forth in the claims.

What is claimed is:

1. A palm support structure of a mouse, being a structure combined with a mouse body, and comprising:
an auxiliary body, installed at any position of an edge of the mouse body, and having a second connecting element; and
a first connecting element, installed on the mouse body, and corresponding to the second connecting element;
thereby, when said first and second connecting elements are latched to combine said mouse body and said auxiliary body together and allow a user to operate said mouse, an index finger and a middle finger of the user's palm are attached onto a surface of said mouse body, and a ring finger, a smaller finger, a thumb or a wrist abuts against said auxiliary body, such that if the user slides said mouse body, said ring finger, smaller finger, thumb or wrist will not rub on a tabletop to cause injuries.

2. The palm support structure of a mouse according to claim 1, wherein said first and second connecting elements are magnets attracted with each other.

3. The palm support structure of a mouse according to claim 1, wherein said first and second connecting elements are an opening and a hook, an embedded groove and an embedding member, or both magnetic materials.

4. The palm support structure of a mouse according to claim 1, wherein said auxiliary body is disposed on a right edge of said mouse body.

5. The palm support structure of a mouse according to claim 1, wherein said auxiliary body is disposed on a left edge of said mouse body.

6. The palm support structure of a mouse according to claim 1, wherein said auxiliary body is disposed at a rear portion of said mouse body.

7. The palm support structure of a mouse according to claim 1, wherein said auxiliary body has a bottom surface aligned evenly with a bottom surface of said mouse body, such that said auxiliary body and said mouse body can be placed flatly on a tabletop.

8. The palm support structure of a mouse according to claim 1, wherein said auxiliary body has a bottom surface disposed on the top of said mouse body and combined with said mouse body, and said bottom surface of said auxiliary body maintains a predetermined distance from said tabletop.

9. The palm support structure of a mouse according to claim 1, wherein said auxiliary body surface is a concave arc surface.

10. The palm support structure of a mouse according to claim 1, wherein said auxiliary body surface is a continuous wavy surface.
